(19) United States
(12) Patent Application Publication
(10) Pub. No.: US 2004/0031765 A1
(43) Pub. Date: Feb. 19, 2004

(54) Milk filtration and filter regeneration

(76) Inventors: Anders Bjork, Tumba (SE); Magnus Lidman, Ronninge (SE)

Correspondence Address: HARNESS, DICKEY & PIERCE, P.L.C., P.O. BOX 8910, RESTON, VA, 20195, US

(21) Appl. No.: 10/343,854

(22) PCT Filed: Sep. 12, 2001
(86) PCT No.: PCT/SE01/01944

(30) Foreign Application Priority Data
Sep. 12, 2000 (SE) 0003226.8

(51) Int. Cl. C02F 1/00

(52) U.S. Cl. 210/793

(57) ABSTRACT

The present invention refers to an apparatus (11) and a method for milk filtration and filter regeneration. The apparatus comprises a filter vessel (13); a loose filter material (37) housed within the vessel for filtering out contaminants in the milk; and a grid (31) arranged in front of the milk flow outlet to prevent the loose filter material from leaving the vessel. The vessel includes inner walls (15, 17); a milk inlet (21); a milk outlet (23); a cleaning fluid inlet (23) arranged substantially vertically at the lowermost portion of the vessel, through which a cleaning fluid jet can be injected, and a cleaning fluid outlet (21) arranged at the upper portion of the vessel. The lower portions (17) of the inner walls of the vessel form an angle (α) with respect to the horizontal plane, the angle being larger than the angle of repose for the filter material in the cleaning fluid. Thus, the filter material, which is flowed vertically upwards (45) by the cleaning fluid jet, moves substantially radially outwards (45) with respect to the jet to descend downwards (47) and slide back (47) towards the jet by aid of the angled inner wall portions.

### TECHNICAL FIELD OF THE INVENTION

The present invention generally relates to dairy farm machine milking and to milk filtering related thereto.

Particularly, the invention relates to apparatus and methods for milk filtration and filter regeneration, to automated milking machines and automated milking systems comprising such a milk filtration apparatus, and to methods of milking.

### DESCRIPTION OF RELATED ART AND BACKGROUND OF THE INVENTION

When a milking animal, such as a cow, presents for milking it is important to ensure that the teatcups to be attached to the teats of the milking animal are clean and free of any condition that could contaminate the milk drawn from the milking animal. This need applies to both manual and automatic application of milking apparatus. Therefore, it is customary to wash the teatcups between the milking of each milking animal, either a cleaning liquid or only water is used.

Nevertheless, there may still be solid contaminants, such as e.g. animal hairs, and dirt, left at the teats, which can be drawn into the milk lines connected to the teatcups by the milking vacuum typically employed. Further, the animal may kick off a teatcup during milking and thus feed remainings or similar on the floor may be drawn into the teatcup. The contaminants are typically rather large particles and have low density. Thus, filtration is a suitable separation technique.

Milk filtration is, however, complicated as the milk contains emulsified fat, which appears as small spherical particles having a diameter of up to 10 microns. Each such particle is enclosed by a protein layer, which prevents agglomeration and thus preserves the fat in an emulsion. Any filter has to allow the fat to pass through while effectively hindering the contaminants. If fat is prevented from passing through, the filter is rapidly clogged.

One known milk filter is disclosed in U.S. Pat. No. 4,292,180 issued to Zylka et al. and comprises a open-end tubular filter sock composed of a folded sheet of spun bonded, randomly oriented, continuous, synthetic fibers, the folded ends of which being joined together. The milk is typically passed through the filter sock, while contaminants are settled in the randomly formed labyrinths of the filter fibers.

A drawback of such a filter, however, is that it has to be changed regularly since separated contaminants are settled partly within the filter layer. Such demands for changes are difficult to fulfill in an automated milking system with a more or less continous milk flow.

Further, such changes are typically performed manually and they thus involve time consuming and costly work, sometimes also at very inconvenient times.

### SUMMARY OF THE INVENTION

Accordingly, it is an object of the present invention to provide a filter apparatus for milk filtration, which is renewable, particularly automatically renewable.

It is in this respect a particular object of the invention to provide such a filter apparatus, which is effective, fast, accurate, reliable, easy to install, and particularly of low cost.

It is a further object of the invention to provide such apparatus, which is suitable to be arranged close to a milking machine in an area wherein animals, such as cows, are allowed to move about freely, to filter the milk output from said milking machine.

Yet further objects of the present invention are to provide an automated milking machine and a milking system, respectively, comprising a milk filtration apparatus of the above said kind.

Still further objects of the invention are to provide a method for milk filtration and filter regeneration, which is effective and which can perform the regeneration automatically, and to provide a method of milking comprising said method for milk filtration and filter regeneration.

These objects among others are, according to the present invention, attained by apparatus, machines, systems and methods as claimed in the appended claims.

By providing the filter apparatus with lower inner walls portions, which form an angle α with respect to the horizontal plane, the angle α being larger than the angle of repose for the filter material in the cleaning fluid used, it is ensured that all filter material will be effectively washed during regeneration.

By arranging the filter apparatus between the milk output of an automated milking machine and the input of a cooler, particularly a plate cooler, in an area wherein animals, such as cows, are allowed to move about freely, milk of high quality is obtained. The filtered and cooled milk is then pumped to a remotely located milk storage tank, from where a milk lorry can collect the milk on regular time basis.

Further characteristics of the invention and advantages thereof will be evident from the following detailed description of embodiments of the invention.

### BRIEF DESCRIPTION OF THE DRAWINGS

The present invention will become more fully understood from the detailed description of embodiments of the present invention given hereinbelow and the accompanying FIGS. 1-3, which are given by way of illustration only, and thus are not limitative of the present invention.

FIG. 1 displays schematically a side elevation view of an embodiment of an apparatus for milk filtration and filter regeneration arranged in filtration mode, according to the present invention.

FIG. 2 displays schematically a side elevation view of the apparatus of FIG. 1 arranged in regeneration mode.

FIG. 3 illustrates schematically a top view of an animal arrangement for housing a herd of cows and a milk storage tank arrangement, respectively, encompassing the filter apparatus of FIGS. 1-2.

### DETAILED DESCRIPTION OF EMBODIMENTS

In the following description, for purposes of explanation and not limitation, specific details are set forth, such as particular techniques and applications in order to provide a thorough understanding of the present invention. However, it will be apparent to one skilled in the art that the present invention may be practiced in other embodiments that depart from these specific details. In other instances, detailed descriptions of well-known methods and apparatuses are omitted so as not to obscure the description of the present invention with unnecessary details.

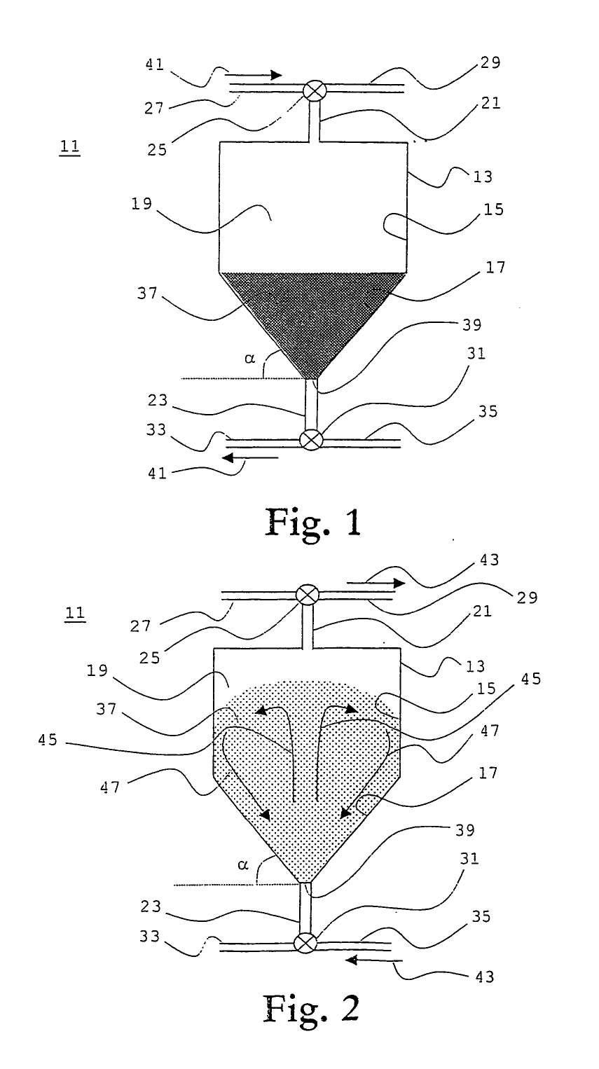

Referring to FIGS. 1 and 2, which show an apparatus 11 for milk filtration and filter regeneration, as being arranged in filtration mode and in regeneration mode, respectively, a preferred embodiment of the present invention will be described.

Apparatus 11 comprises a filter vessel 13 extending substantially vertically and including inner walls 15, 17 enclosing a filter vessel interior 19, a milk flow inlet/cleaning fluid outlet combination 21 arranged at an upper portion of filter vessel 13, and a milk flow outlet/cleaning fluid inlet combination 23 arranged at the lowermost portion of filter vessel 13.

Milk flow inlet/cleaning fluid outlet combination 21 is further, by means of a three-way valve 25, connected to a milk feeding pipe 27 and a cleaning fluid discharge pipe 29, respectively. Correspondingly, milk flow outlet/cleaning fluid inlet combination 23 is, by means of a three-way valve 31, connected to a milk discharge pipe 33 and a cleaning fluid feeding pipe 35, respectively.

Three-way valves 25 and 31 are preferably operated simultaneously such that, prior to filtration, milk feeding pipe 27 is arranged in open communication with milk flow inlet/cleaning fluid outlet combination 21 simultaneously as milk discharge pipe 33 is arranged in open communication with milk flow outlet/cleaning fluid inlet combination 23. Correspondingly, prior to regeneration, cleaning fluid discharge pipe 29 is arranged in open communication with milk flow inlet/cleaning fluid outlet combination 21 simultaneously as cleaning fluid feeding pipe 35 is arranged in open communication with milk flow outlet/cleaning fluid inlet combination 23.

Further, apparatus 11 comprises a loose filter material 37 housed in vessel interior 19. The loose filter material 37 may be a bed of granulates, loose fiber units, or similar. A grid or grating 39 is arranged in front of milk flow outlet/cleaning fluid inlet combination 23 to prevent loose filter material 37 from leaving vessel interior 19 through milk flow outlet/cleaning fluid inlet combination 23. Thus, the holes in grid 39 are small enough so as to not allow the loose filter material to pass through, but large enough so as to allow milk, and the protein covered fat particles therein, to pass through.

During filtration (FIG. 1) a milk flow is passed, preferably pumped, through milk feeding pipe 27, three-way valve 25, and milk flow inlet 21, to reach interior 19 of vessel 13. The milk is passed the loose filter material bed 37, which filters out contaminants in the milk, whereafter the filtered milk is passed through milk flow cutlet 23 at the bottom of vessel 13, and is further passed through three-way valve 31 and out in milk discharge pipe 33. The flow of milk is schematically indicated in FIG. 1 by arrows 41. The filtration function is obtained by the network of passages formed by the filter bed; the milk is passed through such passages or channels whereas contaminants are caught within them. Such filter is particularly advantageous for capturing fibrous contaminants such as e.g. animal hairs. Even a hair of a diameter smaller than the diameter of the fat particles in the milk (which are let through the filter bed) can be caught by the channel system of the filter bed. Crucial filter parameters include size and form of the filter material, obtained packing degree, and the height of the filter bed.

During regeneration (FIG. 2) a cleaning fluid jet is entered into vessel 13 through cleaning fluid feeding pipe 35, three-way valve 31, and cleaning fluid inlet 23. Such cleaning fluid jet is directed substantially vertically upwards and fluidizes the loose filter material 37 and washes out contaminants collected in filter material 37 during filtration. The cleaning fluid together with low density contaminants are discharged from vessel 13 through cleaning fluid outlet 21, three-way valve 25 and cleaning fluid discharge pipe 29, while the loose filter material, being preferably of high density, stays within vessel 13. In FIG. 2 the flow of cleaning fluid is schematically indicated by arrows 43 and the flow of filter material is schematically indicated by arrows 45 and 47. Note also that the distribution of the filter material within filter vessel 13 is simplified in FIG. 2; the distribution is probably strongly irregular during all parts of the regeneration.

By the provision of such backflush of a suitable flow rate the filter bed fluidizes, i.e. the cleaning fluid jet is lifting individual filter particles of the filter bed and keep them suspended. Lighter contaminants follow the cleaning fluid out through the cleaning fluid outlet 21, and in such manner the filter material is washed and contaminants are removed from the filter vessel 13.

In order to obtain an effective regeneration cycle, the lower portions 17 of the inner walls 15, 17 of filter vessel 13 are, according to the present invention, inclined so as to form an angle α with respect to the horizontal plane, wherein the angle α is larger than the angle of repose for loose filter material 37 in the cleaning fluid used.

The angle of repose is defined as the maximum inclination angle, which a slope of a granular or grainy material can exhibit without the equilibrium of the individual granulates or grains being disturbed such that the slope slides or slips. The angle is identical with the natural slope angle, which a granular or grainy material is taking when it is allowed to fall freely towards a planar surface. The angle of repose of a granular material reflects its inner friction, which is a combination of the contact friction between the particles and the locking effects that occur as a result of the irregular form of the individual particles. An increased degree of packing is also contributing to an increased degree of inner friction. Note that the angle of repose is different in a liquid, such as in the cleaning liquid used, than in the open air.

By such provision it is ensured that the loose filter material 37, being flowed substantially vertically upwards by the cleaning fluid jet, move substantially radially outwards with respect to the jet, to descend downwards and slide back towards the cleaning fluid flow by aid of the angled inner wall portions 17 of vessel 13. Any dead spaces or corners, wherein filter material may get caught and thus not participate in the regeneration, are effectively avoided.

The backflush is thus performed with a high velocity turbulent liquid flow in a central portion of the filter bed, whereby these central filter material portions are transported rapidly upwards and toward the peripheral portions of filter vessel 13, where they follow the peripheral walls downwards to reach again the central flow. The flow out of filter vessel 13 is considerably lower than the flow circulating within filter vessel 13. The regeneration is thus utilizing a principle of uneven fluidization and formation of paths through the filter bed.

In one version of the invention the apparatus 11 exhibit a cylindrical symmetry with respect to a vertical axis through milk flow inlet/cleaning fluid outlet combination 21 and milk flow outlet/cleaning fluid inlet combination 23. Hence, the loose filter material, during regeneration, exhibits a toroidal movement 45, 47 induced by the fast central flow.

In another version of apparatus 11 filter vessel 13 is provided with a plurality of substantially rectangular inner walls 15 and a plurality of substantially triangular inner walls 17 to define an enclosure for the loose filter material 37.

The cleaning fluid may preferably comprise a suitable detergent or it may be pure hot water. In the former case, pure water is preferably passed through the vessel 13 subsequent to the cleaning fluid such that it may be ensured that all detergent is removed from the filter vessel and material prior to milk filtration.

In any case the regeneration has to be performed thoroughly as the milk filtration gives rise to milk coatings, which have to be removed (e.g. resolved by the employment of chemicals). A cleaning fluid rate, which provides for such cleaning, has to be provided without the filter material being flushed away. Thus, the density of the filter material has to be considerably higher, preferably much higher, than the density of the cleaning fluid used, while preferably low-density contaminants are washed away.

Further, milk flow outlet/cleaning fluid inlet 23 of apparatus 11 may be connectable to vacuum. In such instance air is preferably drawn trough the filter vessel and filter material subsequent to the flow of cleaning fluid or water, whereby the filter material is dried.

In the apparatus embodiment as depicted, the milk flow inlet and the cleaning fluid inlet coincide and the milk flow outlet and the cleaning fluid outlet coincide. However, in an alternative embodiment (not illustrated) there may be four separate inlets and outlets such that the milk flow inlet and outlet are separated from the cleaning fluid inlet and outlet.

The filter apparatus thus described is simple, effective, accurate, precise, reliable, easy to install and of low cost.

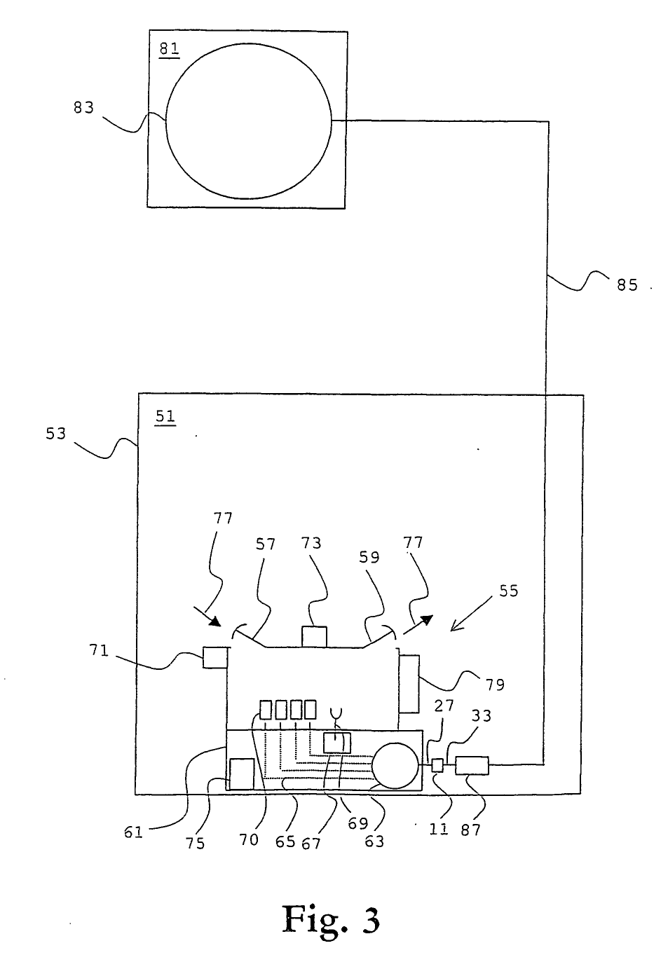

With reference now to FIG. 3, which schematically illustrates an animal arrangement for housing a herd of cows and a milk storage tank arrangement, respectively, a preferred embodiment of an implementation of the filter apparatus of FIGS. 1-2 will be depicted. The animal arrangement comprises an area 51 defined by enclosure means 53 in the shape of a fence, a grid or the like. Area 51 is arranged to house cows permitted to walk about freely.

In area 51, there is provided a milking station 55 arranged for voluntary milking of the freely walking cows, i.e. the cows enter the milking station 55 in order to be milked. The milking station 55 comprises an enclosure having an inlet gate 57 and an outlet gate 59.

The milking station 55 comprises an automatic milking machine 61 connected to a milk receiver 63, also referred to as an end unit, by means of milk lines 65. In milk receiver 63 air is removed from the milk. Milking machine 61 includes an automatic handling device 67 having a robot arm 69 arranged to automatically apply teatcups 70 of the milking machine to the teats of a cow present in the milking station 55.

The milking station 55 comprises additionally an identification member 71 provided to identify a cow approaching the milking station 55. Gates 57 and 59 are controllable by means of a schematically disclosed gate control device 73.

Further, automatic handling device 67, and gate control device 73 are connected to a central processing and control device 75. The central processing and control device 75 is responsible for central processing and controlling of the animal arrangement, and comprises typically a microcomputer, suitable software, and a database of the cows in the area 51. Thus a cow approaching the milking station may be given access to the milking station after having been identified by the identification member 71 by opening of the inlet gate 57. Alternatively, the cow may be identified within the milking station and may be milked or allowed to exit the milking station depending on the identification.

During milking, milk is drawn from the teats of the cow by means of vacuum being applied to the teatcups 70. The milk drawn is measured by means of one or several milk meters (not illustrated), whereafter it is collected in end unit 63. Preferably, there is provided a milk meter for each teatcup for measuring the individual milk flow from each teat. Further, each teatcup is preferably connected individually by means of respective milk line 65 to end unit 63. After the milking has been completed the cow may leave the milking station 55 by opening of the outlet gate 59. In FIG. 3 arrows 77 indicate schematically the flows of cows through milking station 55.

The milking station 55 may also comprise a first feeding device 79 provided in the front end of the milking station 55. A purpose of such feeding device 79 is to entice the cow to enter the milking station 55 and to make her stand still during at least the attachment of the teatcups.

A second area 81, located remote of the first area 51, houses a milk storage tank 83 for storing milk collected from milking station 55 and milking machine 61. For the purpose a milk transportation line 85 is provided and interconnected between end unit 63 of milking machine 61 and milk storage tank 83. Subsequent to each milking the milk collected in end unit 63 is transported, preferably pumped by a pump (not illustrated), through transportation line 85. Thus, end unit 63 shall be sized to house the milk and air from a single milking of a cow, which typically is up to 30 l. Milk storage tank 83 shall be capable of storing milk from all milkings performed by milking machine 61, and possibly by other milking machines, if any, in area 51 or in adjacent areas, during a time period as specified by the frequency at which a milk lorry comes and empties milk storage tank 83. A typical milk storage tank 83 is capable of storing several thousand liters of milk.

According to the present invention the filter apparatus 11 of FIGS. 1-2 and a plate cooler 87 are provided in area 51 interconnected between end unit 63 and milk storage tank 83. (The equipment is only schematically indicated and the cleaning fluid feeding and discharge pipes of apparatus 11 are omitted.) Thus, the milk collected in end unit during a milking is directly after milking filtered and cooled and then pumped through transportation line 85 to milk storage tank 83 for storage until a milk lorry or similar is coming to collect it.

The closed inventive filter apparatus 11, which does not need regular changes of filter material, puts less demands on the hygienic level of the environment and can therefore be arranged in such area 51 or in an animal stall adjacent the milking machine. Thus, any contaminants in the milk are removed earliest possible and the risk of having them dissolved in the milk, or ground into fine particles, is considerably reduced.

The regeneration is typically performed more rarely than subsequent to each milking. Preferably, regeneration is performed after a predetermined number of milking or on a regular time basis such as e.g. three times a day. Regeneration of the filter may also be started subsequent to the milking of a cow if e.g. the central processing and control device 75 has registered that any unexceptional circumstances prevail, such as e.g. that a teatcup has been kicked off or was dropped during attachment to a teat or similar. In such manner the milk from subsequent milkings is prevented from being contaminated by contaminants stucked in the filter at such unexceptional circumstances.

Preferably filter apparatus 11 is regenerated simultaneously as, or in connection with, the cleaning of the milking machine, its end unit, and possibly the transportation line and the milk storage tank. More preferably, the filter apparatus 11 is regenerated before and after such milking machine cleaning.

Such cleaning of the milking machine and the filter apparatus may be performed in a manner briefly outlined in the following. Milk remainings are removed by blowing air through milk lines and vessels of the milking machine/filter apparatus combination by means of a vacuum or compressed air system, followed by flowing water through the same apparatus parts. The blowing of air and flowing of water through the apparatus parts may be repeated a number of times. The filter apparatus is back flushed with water in order to remove contaminants caught in the filter bed.

Then, the milking machine/filter apparatus combination is cleaned with hot water mixed with a suitable detergent. The cleaning solution is recirculated or is passed through the apparatus parts to a drain or to be collected in a tank. This cleaning includes also cleaning of the filter apparatus in order to remove milk remainings still present in the filter bed and the hygiene is thus maintained. After such flow of cleaning solution the apparatus parts are rinsed with water.

If the milking machine is cleaned by a circulating flow of cleaning solution a rather small volume of cleaning solution is used. This flow shall at least during a short period be passed through the filter apparatus in the forward direction (i.e. from top to bottom) in order to collect coarse contaminants, which follow the fluid flow, in the filter bed. These contaminants are subsequently removed by back flushing the filter apparatus with rinse water.

Finally, left rinse water is removed by blowing of air. Such blowing may be used for removal of cleaning fluid as well, and in such instance the amount of rinse water may be reduced.

By the provision of plate cooler 87 adjacent the milking machine the milk is rapidly cooled, and is thereafter transported in transportation line 85. Thus, it is prevented that any increase of bacteria in the milk speeds up.

By arranging the plate cooler 87 downstream of the filter apparatus 11 the risk of contaminants getting stuck between the plates of the plate cooler 87 and thus clogging the cooler (or reducing the cooling efficiency), is avoided.

In an alternative version the inventive filter apparatus is integrated with the end unit of the milking machine to preferably constitute the lower portions thereof.

It shall be further appreciated that the filter apparatus of the present invention may be used for filtration of other liquids than milk. The inventive filter apparatus may be used for filtration of a large variety of liquids including particularly liquid victuals or foodstuff.

It will be obvious that the invention may be varied in a plurality of ways. Such variations are not to be regarded as a departure from the scope of the invention.

All modifications as would be obvious to a man skilled in the art are intended to be included within the scope of the appended claims.

1. An apparatus (11) for milk filtration and filter regeneration, said apparatus being arrangable in a filtration mode and in a regeneration mode, respectively, and characterized in:
a filter vessel (13) extending substantially vertically and including inner walls (15, 17) enclosing a filter vessel interior (19), a milk flow inlet (21) arranged at an upper portion of said filter vessel, through which inlet said vessel interior in said filtration mode is receiving a milk flow, and a milk flow outlet (23) arranged at a lower portion of said filter vessel, through which outlet a filtered milk flow in said filtration mode is discharged from said vessel interior;
a loose filter material (37) housed in said vessel interior for filtering out, in the filtration mode, contaminants in said milk flow; and
a grid means (39) arranged in front of said milk flow outlet for preventing said loose filter material from leaving said vessel interior through said milk flow outlet; said vessel further including:
a cleaning fluid inlet (23) arranged substantially vertically at the lowermost portion of said vessel, through which inlet said vessel interior in said regeneration mode is receiving a cleaning fluid flow, and a cleaning fluid outlet (21) arranged at the upper portion of said filter vessel, through which outlet said received cleaning fluid flow in said regeneration mode is discharged from said vessel interior; wherein
the lower portions (17) of the inner walls of said filter vessel are defining an angle (α) with respect to the horizontal plane, said angle being larger than the angle of repose for said loose filter material in said cleaning fluid such that said loose filter material, in the regeneration mode, being flowed substantially vertically upwards (45) by said cleaning fluid flow, move substantially radially outwards (45) with respect to said flow, to descend downwards (47) and slide back (47) towards said substantially axially cleaning fluid flow by aid of said angled inner wall portions.

2. The apparatus as claimed in claim 1, wherein said milk flow inlet and said cleaning fluid outlet coincide, and wherein said milk flow outlet and said cleaning fluid inlet coincide.

3. The apparatus as claimed in claim 1 or 2, wherein said inner walls of said filter vessel exhibit a cylindrical symmetry with respect to a vertical axis, whereby said loose filter material, in the regeneration mode, exhibit a toroidal movement.

4. The apparatus as claimed in any of claims 1-3, wherein the density of the loose filter material is higher, preferably considerably higher, than the density of the cleaning fluid used.

5. The apparatus as claimed in any of claims 1-4, wherein said cleaning fluid inlet or said milk flow outlet is connectable to vacuum for drawing air through said loose filter material subsequent to the flow of cleaning fluid, whereby said loose filter material is dried.

6. The apparatus as claimed in any of claims 1-5, wherein said loose filter material comprises granulates.

7. The apparatus as claimed in any of claims 1-6, wherein said loose filter material comprises loose fiber units.

8. The apparatus as claimed in any of claims 1-7, wherein said apparatus is arranged at the milk output of an automated milking machine (61) for filtering milk output from said machine.

9. The apparatus as claimed in any of claims 1-7, wherein said apparatus is integrated into an end unit of an automated milking machine for filtering milk collected by said machine.

10. The apparatus as claimed in any of claims 1-9, wherein said apparatus is arranged at the input of a cooling means (87), particularly a plate cooler or heat exchanger, for filtering milk input to said cooler.

11. An automated milking machine (61) comprising the apparatus for milk filtration and filter regeneration as claimed in any of claims 1-7.

12. The milking machine as claimed in claim 11, further comprising a cooling means (87), particularly a plate cooler or heat exchanger, connected to said milk flow outlet of said filtration and regeneration apparatus.

13. A milking system comprising:
an automated milking machine (61);
an apparatus (11) for milk filtration and filter regeneration as claimed in any of claims 1-7 for filtration of milk collected by said machine, said automated milking machine and said apparatus for milk filtration and filter regeneration being located in a first area (51), in which animals, such as cows, are allowed to move about freely;
a milk storage tank (83) for storing milk collected from a plurality of milkings by said automated milking machine, said milk storage tank being located in a second area (81) accessible by a milk lorry, said second area being located remote of said first area; and
a transportation line (85) for transportation of filtered milk from said apparatus for milk filtration and filter regeneration to said milk storage tank.

14. The system as claimed in claim 13, further comprising a cooling means (87), particularly a plate cooler or heat exchanger, interconnected between said apparatus (11) for milk filtration and filter regeneration and said transportation line (85).

15. A method for milk filtration and filter regeneration in a filter apparatus (11), characterized by the steps of:
entering (41) a milk flow in an upper portion of said filter apparatus;
filtering out contaminants in said milk flow by means of passing said milk flow through loose filter material (37) housed within said filter apparatus;
discharging (41) said filtered milk flow from said apparatus at a lower portion of said filter apparatus;
injecting (43) a cleaning fluid flow substantially vertically into said filter apparatus from the lowermost portion of said apparatus such that said loose filter material is flowed substantially vertically upwards (45) by said cleaning fluid flow, to move substantially radially outwards (45) with respect to said flow and descend downwards (47);
discharging (43) said cleaning fluid flow from said apparatus at an upper portion of said filter apparatus; and
forcing the loose filter material to slide back (47) towards said substantially vertical cleaning fluid flow by aid of inner wall portions (17) of said filter apparatus, which are defining an angle (α) with respect to the horizontal plane, said angle being larger than the angle of repose for said loose filter material in said cleaning fluid.

16. The method as claimed in claim 15, wherein the loose filter material, being particularly composed of loose fiber units and/or granulates, is forced to circulate so as to define a toroidally formed movement, which is cylindrically symmetric with respect to a vertical axis.

17. The method as claimed in claim 15, wherein the steps of entering a milk flow, filtering out contaminants, and discharging said filtered milk flow are performed subsequent to each of a plurality of milkings, and the steps of injecting a cleaning fluid, discharging said cleaning fluid, and forcing the loose filter material to slide back are performed more rarely, particularly after a predetermined number of milkings or on a regular time basis.

18. A method of milking animals, such as cows, which are allowed to move freely in an area (51) intended therefore and to visit individually an automated milking machine (61), said method comprising milking an animal during a visit to the automated milking machine and filtering the milk obtained from said milking by the apparatus (11) as claimed in claim 1-7, said apparatus being arranged in close vicinity to said automated milking machine.

19. The method as claimed in claim 18, comprising transporting said filtered milk to a milk storage tank (83) located in a second area (81) accessible by a milk lorry, said second area being located remote of the area intended to house animals.

20. The method as claimed in claim 19, comprising cooling the filtered milk prior to transporting it to the milk storage tank.

21. An apparatus (11) for liquid filtration and filter regeneration, said apparatus being arrangable in a filtration mode and in a regeneration mode, respectively, and characterized in:
a filter vessel (13) extending substantially vertically and including inner walls (15, 17) enclosing a filter vessel interior (19), a liquid flow inlet (21) arranged at an upper portion of said filter vessel, through which inlet said vessel interior in said filtration mode is receiving a liquid flow, and a liquid flow outlet (23) arranged at a lower portion of said filter vessel, through which outlet a filtered liquid flow in said filtration mode is discharged from said vessel interior;
a loose filter material (37) housed in said vessel interior for filtering out, in the filtration mode, contaminants in said liquid flow; and
a grid means (39) arranged in front of said liquid flow outlet for preventing said loose filter material from leaving said vessel interior through said liquid flow outlet; said vessel further including:
a cleaning fluid inlet (23) arranged substantially vertically at the lowermost portion of said vessel, through which inlet said vessel interior in said regeneration mode is receiving a cleaning fluid flow, and a cleaning fluid outlet (21) arranged at the upper portion of said filter vessel, through which outlet said received cleaning fluid flow in said regeneration mode is discharged from said vessel interior; wherein
the lower portions (17) of the inner walls of said filter vessel are defining an angle (α) with respect to the horizontal plane, said angle being larger than the angle of repose for said loose filter material in said cleaning fluid such that said loose filter material, in the regeneration mode, being flowed substantially vertically upwards (45) by said cleaning fluid flow, move substantially radially outwards (45) with respect to said flow, to descend downwards (47) and slide back (47) towards said substantially axially cleaning fluid flow by aid of said angled inner wall portions.
